(19) United States
(12) Patent Application Publication
(10) Pub. No.: US 2021/0209917 A1
(43) Pub. Date: Jul. 8, 2021

(54) PRINTED CIRCUIT BOARD FOR SMOKE DETECTOR

(71) Applicant: Autronica Fire & Security AS, Trondheim (NO)

(72) Inventors: Ole Martin Pedersen, Trondheim (NO); Per Johan Vannebo, Trondheim (NO); Hans Jorgen Svendsen, Trondheim (NO)

(21) Appl. No.: 17/056,537

(22) PCT Filed: May 31, 2018
(86) PCT No.: PCT/EP2018/064380

§ 371 Date: Nov. 18, 2020

(51) Int. Cl. G08B 17/103; G08B 17/06

(52) U.S. Cl. CPC G08B 17/103; G08B 17/06

(57) ABSTRACT

Disclosed is a smoke detector comprising: a housing including a base, the base including a planar surface configured for being positioned against and attached to a ceiling, a printed circuit board (PCB) comprising a substantially planar shape with a front surface and an opposing back surface spaced in a thickness direction T, and a plurality of perimeter edges including a bottom edge and an opposing top edge spaced in a height-wise direction H, a first side edge and an opposing second side edge spaced in a transverse direction, wherein the top edge comprises a first projection extending in the height-wise direction away from the top edge, the first projection including a first temperature sensor height-wise spaced from the top edge, and the PCB is mounted to the housing so that the front surface of the PCB is perpendicular to the planar surface of the base.

### BACKGROUND

Exemplary embodiments pertain to the art of printed circuit boards for smoke detectors and more specifically to a vertically oriented printed circuit board for a smoke detector.

Detecting smoke fires may be performed using a light emitter and a light receiver disposed at an angle relative to each other. The detector may sense light scattered by smoke. An optical smoke detector may consist of a housing that contains a printed circuit board (PCB) and optical components with a detection volume that is isolated from outside light. Optical components may be usually placed in a preform-jig configured for predetermined angles. For heat sensing, a leaded thermistor may be soldered to the PCB. The leads may allow a sensing element to be placed in the airstream. Assembly of traditional detectors may be labor intensive and difficult to automate.

### BRIEF DESCRIPTION

Disclosed is a smoke detector comprising: a housing including a base, the base including a planar surface configured for being positioned against and attached to a ceiling, a printed circuit board (PCB) comprising a substantially planar shape with a front surface and an opposing back surface spaced in a thickness direction T, and a plurality of perimeter edges including a bottom edge and an opposing top edge spaced in a height-wise direction H, a first side edge and an opposing second side edge spaced in a transverse direction, wherein the top edge comprises a first projection extending in the height-wise direction away from the top edge, the first projection including a first temperature sensor height-wise spaced from the top edge, and the PCB is mounted to the housing so that the front surface of the PCB is perpendicular to the planar surface of the base, and the first projection extends away from the planar surface of the base.

In addition to one or more of the above disclosed features or as an alternate the top edge of the PCB includes a first segment which is transversely intermediate the first side edge and the second side edge, the first segment having a profile shape that defines a cutout area in the planar shape of the PCB.

In addition to one or more of the above disclosed features or as an alternate a light detector connected to the first segment at a first location, the light detector being oriented so that a center focus of detection extends along a first axis that extends into the cutout area, and a light emitter connected to the first segment at a second location within the cutout area, the light emitter being oriented so that a center focus of projection extends along a second axis that extends into the cutout area.

In addition to one or more of the above disclosed features or as an alternate at least a first electrical lead extends in the height-wise direction away from the bottom edge of the PCB for electrically connecting the PCB to a base of the smoke detector.

In addition to one or more of the above disclosed features or as an alternate at least a second electrical lead extends in the thickness direction away from the front surface of the PCB for electrically connecting the PCB to a peripheral component.

In addition to one or more of the above disclosed features or as an alternate the first top segment of the PCB includes a first transverse end proximate the first side edge of the PCB, the first transverse end comprising a first projection extending in the height-wise direction away from the first top segment, the first projection including a first temperature sensor.

In addition to one or more of the above disclosed features or as an alternate the first top segment of the PCB includes second transverse end that opposes the first transverse end and is proximate the second side edge of the PCB, the second transverse end comprising a second projection extending parallel to the first projection, wherein the smoke detector includes a plurality of temperature sensors including the first temperature sensor and a second temperature sensor, and wherein the second projection including a second temperature sensor.

In addition to one or more of the above disclosed features or as an alternate the housing includes a first side wall, and the base including a first electrical connector, wherein the first electrical lead in the PCB is electrically connected to the first electrical connector in the base, and the first side edge of the PCB is positioned against the first side wall of the housing.

In addition to one or more of the above disclosed features or as an alternate the smoke detector comprises a smoke chamber positioned over the first segment of the top edge of the PCB, wherein the smoke chamber is positioned transversely between the first projection and the second projection, and wherein the smoke chamber includes: a first cavity for receiving smoke, the first cavity extending away from the top edge of the PCB in the height-wise direction, and the first cavity including at least a first opening for fluidly receiving a flow of smoke and directing the flow of smoke to the plurality of temperature sensors.

In addition to one or more of the above disclosed features or as an alternate the first electrical lead comprises a plurality of electrical pins and the second electrical lead comprises a plurality of electrical mounting hooks.

Further disclosed is a method of manufacturing a smoke detector including one or more of the above disclosed features.

### BRIEF DESCRIPTION OF THE DRAWINGS

The following descriptions should not be considered limiting in any way. With reference to the accompanying drawings, like elements are numbered alike:

FIG. 1 is a schematic illustration of a printed circuit board (PCB) according to a disclosed embodiment;

FIG. 2 illustrates a PCB according to a disclosed embodiment;

FIG. 3 illustrates a PCB installed in a base of a detector housing according to a disclosed embodiment;

FIG. 4 illustrates a front view of a PCB with a smoke chamber according to a disclosed embodiment;

FIG. 5 illustrates a PCB installed in a detector housing according to a disclosed embodiment; and

FIG. 6 is a schematic illustration of a PCB installed in a detector housing according to a disclosed embodiment.

### DETAILED DESCRIPTION

A detailed description of one or more embodiments of the disclosed apparatus and method are presented herein by way of exemplification and not limitation with reference to the Figures.

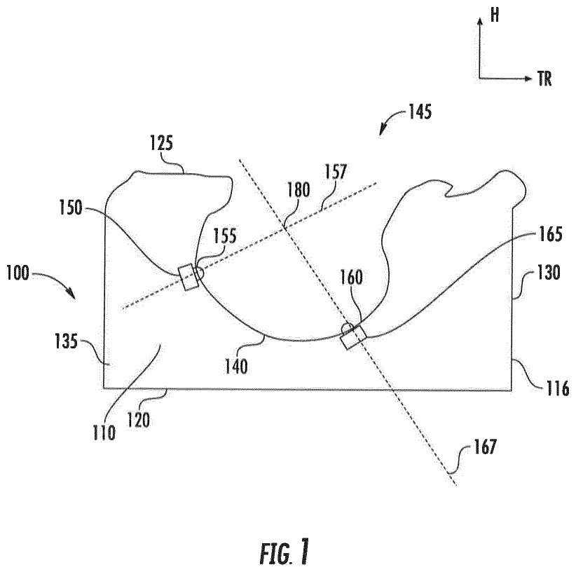

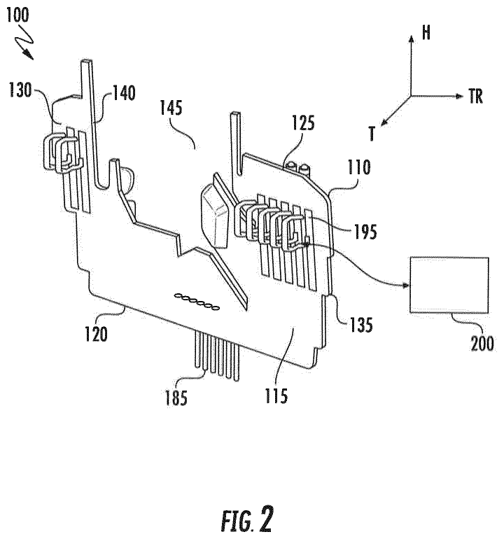

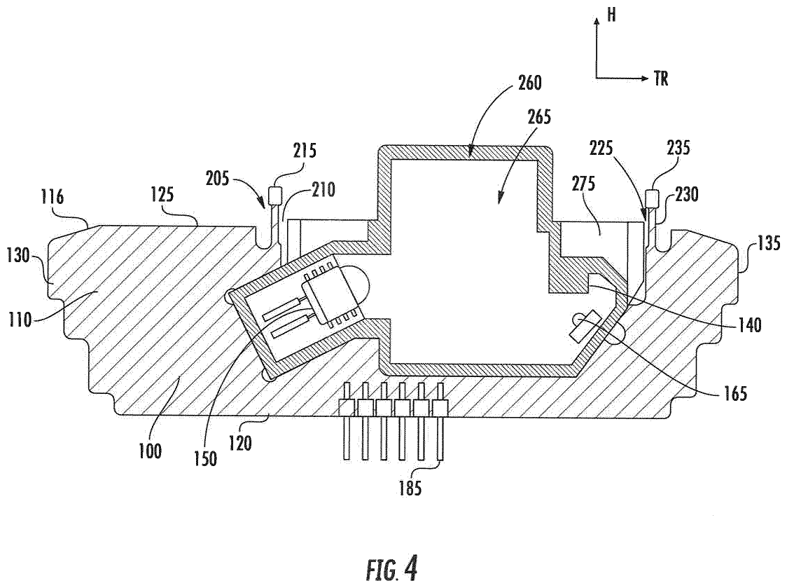

Turning to FIG. 1, schematically disclosed is a printed circuit board (PCB) 100 for a smoke detector 105. The PCB 100 (illustrated in schematically in FIG. 2) may comprise a substantially planar shape with a front surface 110 and an opposing back surface 115 spaced in a thickness direction T (see FIG. 4) defining a plane 116 of the PCB. A plurality of perimeter edges on the PCB 100 may include a bottom edge 120 and an opposing top edge 125 spaced in a height-wise direction H. In addition a first side edge 130 and an opposing second side edge 135 may be spaced in a transverse direction TR.

The top edge 125 may include a first segment 140 which may be transversely intermediate the first side edge 130 and the second side edge 135. The first segment 140 may have a profile shape that may define a cutout area 145 in the planar shape of the PCB 100.

A light detector 150 may be connected to the first segment 140 at a first location 155. The light detector 150 may be oriented so that a center focus of projection extends along a first axis 157 that extends into the cutout area 145. A light emitter 165 may be connected to the first segment 140 at a second location 160 within the cutout area 135. The light emitter 165 may be oriented so that a center focus of detection extends along a second axis 167 that extends into the cutout area 145.

The first axis of 157 for the light detector 150 and the second axis 167 for the light emitter 165 may be parallel to the plane 116 of the PCB 100. In addition, the first axis of 157 for the light detector 150 and the second axis 167 for the light emitter 165 may intersect at a point 180 disposed within the cutout area 145.

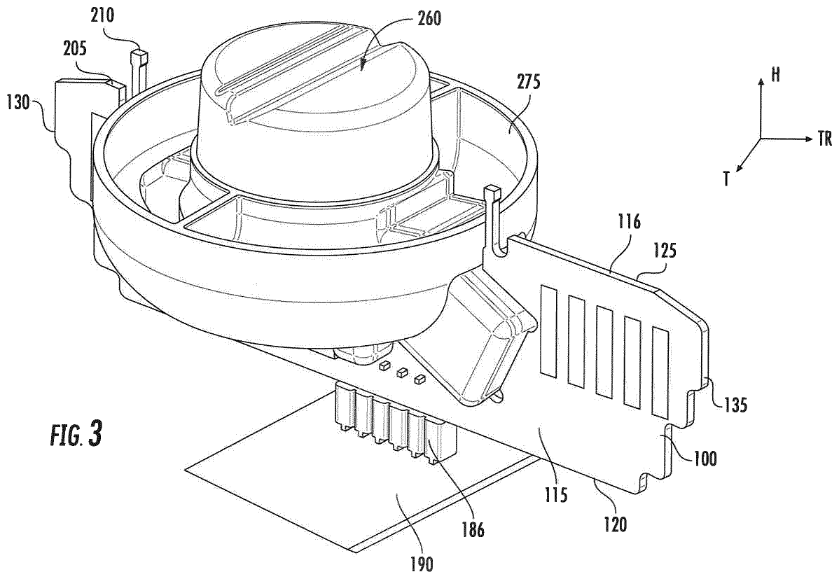

As illustrated in FIG. 2, at least a first electrical lead 185 may extend in the height-wise direction away from the bottom edge 120 within the plane 116 of the PCB 100. In the illustration the first electrical lead 185 is a first plurality of electrical leads and yet more specifically are a plurality of electrical pins. The first plurality of electrical pins may electrically connect the PCB 100 to a port 186 in a base 190 (FIG. 3) of the smoke detector 105 and may receive transmitted network communications and power. The port 186 may be, for example, a serial port.

As further illustrated in FIG. 2, at least a second electrical lead 195 may extend in the thickness direction away from the back surface 115 of the PCB 100. In the illustration, the second electrical lead 195 may be a second plurality of electrical leads and more specifically a plurality of mounting hooks that function similarly to the first plurality of electric leads. That is, the second plurality of electric leads provide power and network to a peripheral 200 that may be supported in the mounting hook formation of the leads. The attached peripheral, illustrated schematically, be further PCB containing a further microcontroller. For example the attached peripheral 200 may be a carbon monoxide (CO), sensor, sounder, beacon, etc., containing features not already in the PCB 100.

As illustrated in FIG. 4, the first top segment 140 of the PCB 100 may include a first transverse end 205 proximate the first side edge 130 of the PCB 100. The first transverse end 205 may include a first projection or stub 210 extending in the height-wise direction in the plane 116 of the PCB 100 away from the top edge 125. The first projection 210 may include a first temperature sensor 215 (illustrated schematically).

In addition, the first top segment 140 of the PCB 100 may include second transverse end 225 that opposes the first transverse end 205 and may be proximate the second side edge 135 of the PCB 100. The second transverse end 225 may include a second projection 230 extending parallel to the first projection 210. The second projection may include a second temperature sensor 235 (illustrated schematically). Both temperature sensors may be thermistor sensors.

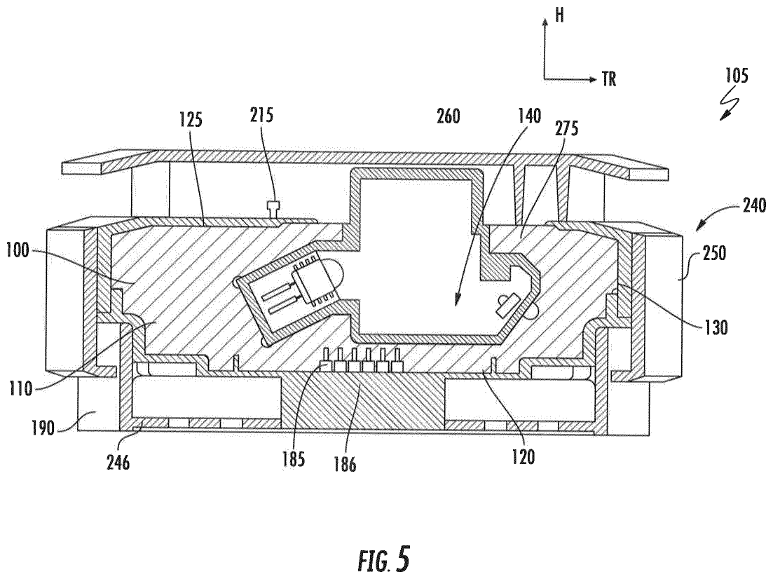

Turing to FIG. 5, with further attention to the smoke detector 105, there may be a housing 240 including the base 190 and a first side wall 250. The base 190 may include a planar surface 246 that may be connected to a ceiling. The base 190 may further include port 186 identified above. The PCB 100 may be fixedly connected to the base 190 so that the bottom edge 120 of the PCB 100 may be disposed against the base 190 and the PCB 100 may extend perpendicularly away from the planar surface 246 of the base 190. In this configuration the first side edge 130 of the PCB 100 may be positioned against the first side wall 250 of the housing 240.

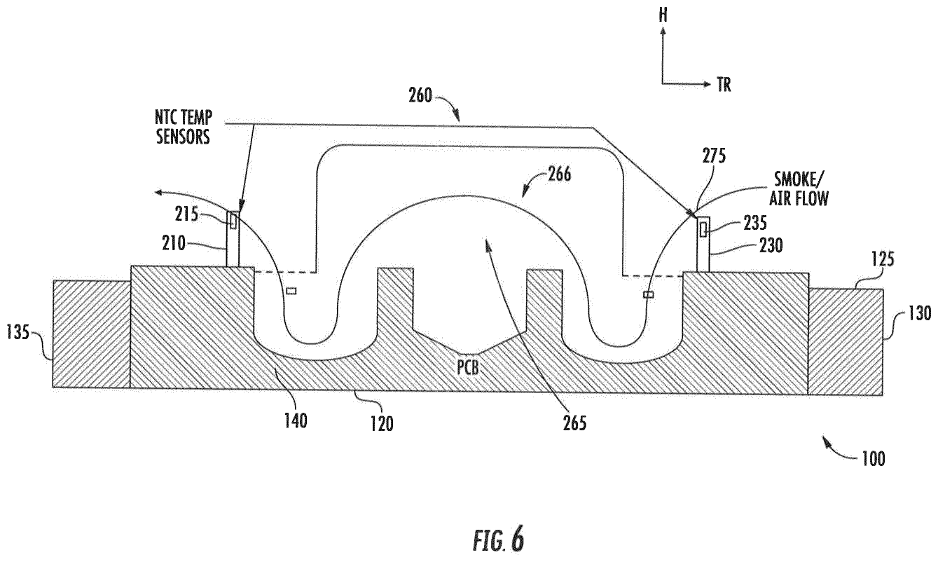

Turning to FIG. 6 the smoke detector 105 may include a smoke chamber 260 which may be positioned over the first segment 140 of the top edge 125 of the PCB 100. The smoke chamber 260 may be positioned transversely between the first projection 210 and the second projection 230, that is, between the temperature sensors 215, 235.

The smoke chamber 260 may include a first cavity 265 for receiving a flow of smoke 266. The first cavity 265 may extend away from the top edge 125 of the PCB 100 in the height-wise direction. The first cavity 265 may include at least a first opening 275 for fluidly receiving smoke. The opening directs air and a flow of smoke 266 to the temperature sensors 215, 235 when entering and exiting the chamber 260.

The above disclosed fire detector design may provide (1) a vertically mounted printed circuit board PCB, perpendicular to a detector mounting plane, (2) a smoke detection structural cut-out (void or volume) within the vertically mounted PCB that intersects inside an area of the PCB, wherein such configuration may provide for increased design versatility, (3) one or more PCB protrusions (stubs) on the vertically mounted PCB which may be suitable for automated mounting of one or more temperature sensors, which may be negative temperature coefficient thermistors (NTCs), (4) one or more side sensing (into the cut-out) surface mounted light emitters and receivers, which may be suitable for automated mounting on the vertically mounted PCB.

The features disclosed herein may be well suited for the inclusion of one or more scattering angles. The disclosed embodiments apply three light sources and one light receiver. The disclosed embodiments also use a PCB that is mounted perpendicular to a mounting plane, though the disclosed features may be applicable to mounting PCBs at many angles relative to the mounting plane. An open area inside the PCB may provide a smoke detection area in which side looking photoelectric detectors (PDs) and light emitting diodes (LEDs) are mounted with multiple angles between them also while the optical axes are parallel to the plane 116 of the PCB 100.

The above disclosed features may provide a way of mounting NTCs in a fire detector. The disclosed embodiments provide surface mounted NTCs to printed circuit board (PCB) stubs. The PCB stubs protrude where there may be air flow, which may provide sensing relatively accurate temperature fluctuations. Due to a low thermal mass of the PCB stub, a temperature response may be increased. Vertical mounting of the PCB may enable relatively optimal access of the airstream.

The above invention combined with detection volume within the PCB may allow for a compact design that is efficiently manufactured. Surface mounted NTCs on PCB stubs may be mounted using automated process during PCB manufacturing. This may reduce or eliminate a need for manual mounting or complex automatic mounting of temperature sensors in a fire detector. Placing a PCB vertically related to a mounting plane may leave more usable space available in a detector, and may allow for protrusion of NTC stubs into the air stream.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A smoke detector 105 comprising:
a housing 240 including a base 190, the base 190 including a planar surface 246 configured for being positioned against and attached to a ceiling,
a printed circuit board (PCB) 100 comprising a substantially planar shape with a front surface 110 and an opposing back surface 115 spaced in a thickness direction T, and a plurality of perimeter edges including a bottom edge 120 and an opposing top edge 125 spaced in a height-wise direction H, a first side edge 130 and an opposing second side edge 135 spaced in a transverse direction,
wherein
the top edge 125 comprises a first projection 210 extending in the height-wise direction away from the top edge 125, the first projection 210 including a first temperature sensor 215 height-wise spaced from the top edge 125, and
the PCB 100 is mounted to the housing 240 so that
the front surface 110 of the PCB 100 is perpendicular to the planar surface 246 of the base 190, and
the first projection 210 extends away from the planar surface 246 of the base 190.

2. The smoke detector 105 of claim 1 wherein
the top edge 125 of the PCB 100 includes a first segment 140 which is transversely intermediate the first side edge 130 and the second side edge 135, and
the first segment 140 having a profile shape that defines a cutout area 145 in the planar shape of the PCB 100.

3. The smoke detector of any of the preceding claims comprising
a light detector 150 connected to the first segment 140 at a first location 155, the light detector 150 being oriented so that a center focus of detection extends along a first axis 157 that extends into the cutout area 145, and
a light emitter 165 connected to the first segment 140 at a second location 160 within the cutout area 135, the light emitter 165 being oriented so that a center focus of projection extends along a second axis 167 that extends into the cutout area 145.

4. The smoke detector 105 of any of the preceding claims wherein at least a first electrical lead 185 extends in the height-wise direction away from the bottom edge 135 of the PCB 100 for electrically connecting the PCB 100 to a base 190 of the smoke detector 105.

5. The smoke detector 105 of any of the preceding claims wherein at least a second electrical lead 195 extends in the thickness direction away from the front surface 130 of the PCB 100 for electrically connecting the PCB 100 to a peripheral component 200.

6. The smoke detector 105 of any of the preceding claims wherein
the first top segment 140 of the PCB 100 includes a first transverse end 205 proximate the first side edge 130 of the PCB 100,
the first transverse end 205 comprising the first projection 210 extending in the height-wise direction away from the first top segment 140.

7. The smoke detector 105 of any of the preceding claims wherein
the first top segment 140 of the PCB 100 includes second transverse end 225 that opposes the first transverse end 205 and is proximate the second side edge 135 of the PCB 100,
the second transverse end 225 comprising a second projection 230 extending parallel to the first projection 210,
wherein the smoke detector 105 includes a plurality of temperature sensors including the first temperature sensor 215 and a second temperature sensor, and
wherein the second projection includes the second temperature sensor 235.

8. The smoke detector 105 of any of the preceding claims wherein
the housing 240 includes a first side wall 250, and the base 190 includes a first electrical connector 186, and
wherein the first electrical lead 185 in the PCB 100 is electrically connected to the first electrical connector 186 in the base 190, and the first side edge 130 of the PCB 100 is positioned against the first side wall 250 of the housing 240.

9. The smoke detector of any of the preceding claims comprising
a smoke chamber 260 positioned over the first segment 140 of the top edge 125 of the PCB 100, wherein the smoke chamber 260 is positioned transversely between the first projection 210 and the second projection 230, and
wherein the smoke chamber 260 includes:
a first cavity 265 for receiving smoke, the first cavity 265 extending away from the top edge 125 of the PCB 100 in the height-wise direction, and
the first cavity 265 including at least a first opening 275 for fluidly receiving a flow of smoke 266 and directing the flow of smoke 266 to the plurality of temperature sensors.

10. The smoke detector of any of the preceding claims wherein:
the first electrical lead 185 comprises a plurality of electrical pins and the second electrical lead 195 comprises a plurality of electrical mounting hooks.

11. A method of manufacturing a smoke detector 105, comprising
obtaining a housing 240 that includes a base 190, the base 190 including a planar surface 246 configured for being positioned against and attached to a ceiling,
forming a printed circuit board (PCB) 100 with a substantially planar shape having a front surface 110 and an opposing back surface 115 spaced in a thickness direction T, wherein the PCB includes a plurality of perimeter edges including a bottom edge 120 and an opposing top edge 125 spaced in a height-wise direction H, a first side edge 130 and an opposing second side edge 135 spaced in a transverse direction,
wherein
the top edge 125 comprises a first projection 210 extending in the height-wise direction away from the top edge 125, the first projection 210 including a first temperature sensor 215 height-wise spaced from the top edge 125, and
the PCB 100 is mounted to the housing 240 so that
the front surface 110 of the PCB 100 is perpendicular to the planar surface 246 of the base 190, and
the first projection 210 extends away from the planar surface 246 of the base 190.

12. The method of claim 11 comprising
forming in the top edge 125 of the PCB 100 a first segment 140 which is transversely intermediate the first side edge 130 and the second side edge 135, and
wherein the first segment 140 having a profile shape that defines a cutout area 145 in the planar shape of the PCB 100.

13. The method of any of claims 11-12 comprising
connecting a light detector 150 to the first segment 140 at a first location 155, the light detector 150 being oriented so that a center focus of detection extends along a first axis 157 that extends into the cutout area 145, and
connecting a light emitter 165 to the first segment 140 at a second location 160 within the cutout area 135, the light emitter 165 being oriented so that a center focus of projection extends along a second axis 167 that extends into the cutout area 145.

14. The method of any of claims 11-13 wherein at least a first electrical lead 185 extends in the height-wise direction away from the bottom edge 135 of the PCB 100 for electrically connecting the PCB 100 to a base 190 of the smoke detector 105.

15. The method of any of claims 11-14 wherein at least a second electrical lead 195 extends in the thickness direction away from the front surface 130 of the PCB 100 for electrically connecting the PCB 100 to a peripheral component 200.

16. The method of any of claims 11-15 wherein
the first top segment 140 of the PCB 100 includes a first transverse end 205 proximate the first side edge 130 of the PCB 100,
the first transverse end 205 comprising the first projection 210 extending in the height-wise direction away from the first top segment 140.

17. The method of any of claims 11-16 wherein
the first top segment 140 of the PCB 100 includes second transverse end 225 that opposes the first transverse end 205 and is proximate the second side edge 135 of the PCB 100,
the second transverse end 225 comprising a second projection 230 extending parallel to the first projection 210,
wherein the smoke detector 105 includes a plurality of temperature sensors including the first temperature sensor 215 and a second temperature sensor, and
wherein the second projection includes the second temperature sensor 235.

18. The method of any of claims 11-17 wherein the housing 240 that includes a first side wall 250 and the base 190 includes a first electrical connector 186,
fixedly connecting the PCB 100 of any of claims 11-17 to the base 190 so that the bottom edge 120 of the PCB 100 is disposed against the base 190,
wherein the first electrical lead 185 in the PCB 100 is electrically connected to the first electrical connector 186 in the base 190, and the first side edge 130 of the PCB 100 is positioned against the first side wall 250 of the housing 240.

19. The method of any of claims 11-18 comprising
positioning a smoke chamber 260 over the first segment 140 of the top edge 125 of the PCB 100, wherein the smoke chamber 260 is positioned transversely between the first projection 210 and the second projection 230, and
wherein the smoke chamber 260 includes
a first cavity 265 for receiving smoke, the first cavity 265 extending in the height-wise direction away from the top edge 125 of the PCB 100, and
the first cavity 265 including at least a first opening 275 for fluidly receiving a flow of smoke 266 and directing the flow of smoke 266 to the plurality of temperature sensors.

20. The method of any of claims 11-19 wherein:
the first electrical lead 185 comprises a plurality of electrical pins and the second electrical lead 195 comprises a plurality of electrical mounting hooks.
